(19) United States
(12) Patent Application Publication
(10) Pub. No.: US 2011/0246721 A1
(43) Pub. Date: Oct. 6, 2011

(54) METHOD AND APPARATUS FOR PROVIDING AUTOMATIC SYNCHRONIZATION APPLIANCE

(75) Inventor: ADRIAN CRISAN, SAN DIEGO, CA (US)

(73) Assignee: SONY CORPORATION, Tokyo (JP)

(21) Appl. No.: 12/751,691

(22) Filed: Mar. 31, 2010

(51) Int. Cl. G06F 12/08; G06F 12/16

(52) U.S. Cl. 711/130; 711/162; 711/E12.103; 711/E12.016

(57) ABSTRACT

A method and apparatus for data backup are disclosed. Embodiments of the method comprise receiving a set of data from a local computer, caching the received data locally on the storage appliance in a buffer module, uploading the cached data to a remote computer, and accessing the set of data using the storage device. Embodiments of the apparatus comprise a network interface module for establishing connection of the storage appliance with at least one computer in a local network and at least one remote computer in a cloud network, a buffer module for receiving data to be backed up from the at least one computer; and a processor.

### BACKGROUND

1. Field of the Invention

Embodiments of the present invention generally relate to data backup techniques and, more particularly, to an automatic synchronization appliance for data backup that connects to a cloud network and coordinates the storage levels and access to the data.

2. Description of the Related Art

In the current computing environment, data and program files are generally stored on computer-based data storage systems (i.e. disk drives). As part of good data management practices, many users perform regular backups of such storage systems. Such backups are commonly stored on external hard drives, removable storage devices, or remote network drives.

Conventionally, there exist various techniques for performing these synchronized backups. However, these techniques often suffer drawbacks and limitations. Local backup devices are generally limited in capacity and provide a single point of failure. Remote network backups are limited in speed and bandwidth. Removable media must be mounted or installed on a computer to access the data.

Therefore, there is a need in the art for a method and apparatus to provide an automatic synchronization appliance.

### SUMMARY OF THE INVENTION

Embodiments of the present disclosure generally disclose an automatic synchronization appliance for data backup and methods thereof. The method comprises receiving a set of data from one or more local computers, caching the received data locally on the storage appliance in a buffer module, uploading the cached data to one or more remote computers, and accessing the set of data using the storage device.

In another embodiment, a storage appliance is provided. The appliance comprises a network interface module for establishing connection of the storage appliance with at least one computer in a local network and at least one remote computer in a cloud network; a buffer module for receiving data to be backed up from the at least one computer; and a processor for off-loading the received backup data from the storage appliance to the at least one remote computer in the cloud network and rendering the backed-up data to the at least one computer such that the backed-up data appears to be stored locally.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a data storage system utilizing an storage appliance for seamless data storage and access of the data, according to some embodiments of the present invention;

FIG. 2 illustrates a block diagram of the storage appliance according to some embodiments of the present invention;

FIG. 3 illustrates a flow diagram of a method for uploading data from the storage appliance to a remote computer in a cloud network according to some embodiments of the present invention;

FIG. 4 illustrates a flow diagram of a method for accessing data stored on a storage appliance in accordance with embodiments of the present invention; and

FIG. 5 illustrates a flow diagram of a method for backing up and off-loading data to a remote computer using a storage appliance in accordance with embodiments of the present invention.

### DETAILED DESCRIPTION

As explained further below, various embodiments of the invention provides an automatic synchronization appliance for data backup and methods thereof. The term “automatic synchronization appliance” and “storage appliance” can be interchangeably used within the specification without departing the meaning and scope of the invention. In particular a storage appliance is disclosed which connects to a cloud network and coordinates the storage levels and access to the data.

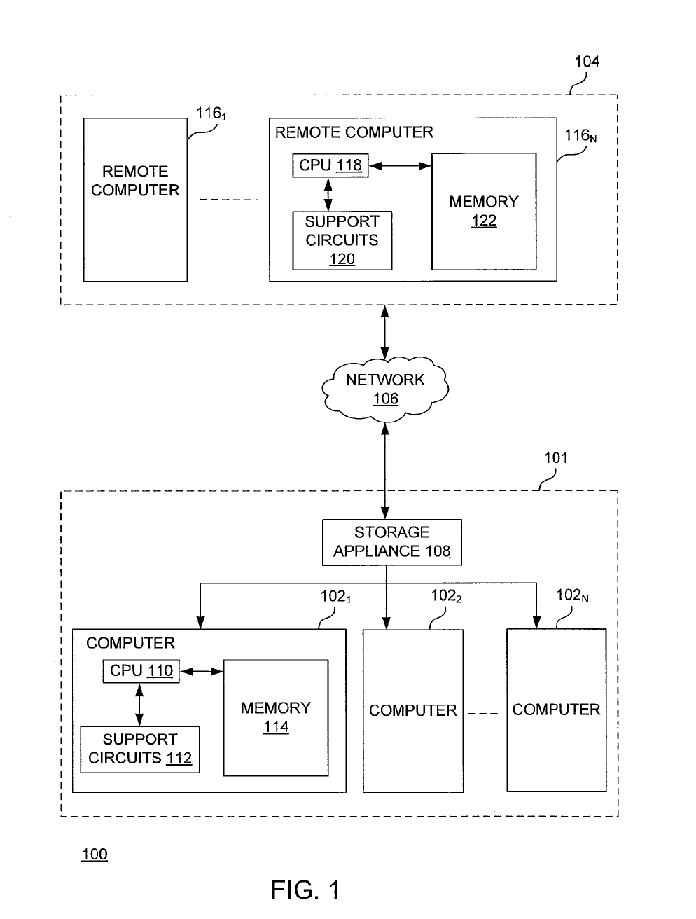

FIG. 1 is a block diagram of a data storage system 100 utilizing a storage appliance for seamless data storage and access of the data, according to some embodiments of the present invention. The system 100 includes a local network 101 and a cloud network 104 operatively coupled to each other through a network 106. The local network 104 comprises one or more computers directly or indirectly coupled to a storage appliance 108. The local network 104 is coupled to the cloud network 104 via a network 106. In some embodiments, the local network 104 is coupled to the network 106 via a gateway. The cloud network 104 is coupled to the network 106. In some embodiments, the cloud network 104 is coupled to the network 106 via a gateway. In some embodiments, the cloud network 104 coupled to the network 106 at multiple points through multiple gateways. Although FIG. 1 represents the cloud network 104 as a single entity with a single access point to the network 106, one of ordinary skill in the art would recognize that such a cloud network could be spread out across the network 106 and the individual remote computers 116 might communicate via such a network 106.

The local network 101 includes one or more computer systems 102₁, 102₂, . . . 102_{N}, connected to a storage appliance 108. According to some embodiments of the present invention, the computer system 102 is a type of a computing device (e.g., a mobile phone, a Personal Digital Assistant (PDA), hand-held gaming device, and/or the like) known to one of ordinary skill in the art having the benefit of this disclosure. The computer system 102 is utilized by a user to access various data, such as local files or Internet resources (e.g., web pages, multimedia files (e.g., dynamic or static content in the form of images, video and/or audio). Further, various types of data (e.g., emails, word documents, spreadsheets and/or the like) and/or program files may be stored on the computer system 102. The system 102 comprises a CPU 110, support circuits 112, and memory 114. The memory 114 may also include storage and a processor (not shown).

The CPU 110 may comprise one or more commercially available microprocessors or microcontrollers that facilitate data processing and storage. Various support circuits facilitate operation of the CPU 110 and may include clock circuits, buses, power supplies, input/output circuits and/or the like. The memory 114 includes a Read Only Memory, Random Access Memory, disk drive storage, optical storage, removable storage, and the like.

The network 106 comprises a communication system that connects computers by wire, cable, fiber optic and/or wireless link facilitated by various types of well-known network elements, such as hubs, switches, routers, and the like. The network 106 may employ various well-known protocols to communicate information amongst the network resources. For example, the network 106 may be a part of the Internet or Intranet using various communications infrastructure, such as Ethernet, WiFi, WiMax, General Packet Radio Service (GPRS), and the like.

The cloud network 104 comprises one or more remote computers, as generally known in the art, such as remote computers 116₁, 116₂, . . . 116_{N}. The cloud network 104 is used to refer to a remote network of computers, such as the Internet, based on the cloud drawing commonly used to depict the Internet in computer network diagrams as an abstraction of the underlying infrastructure it represents. The one or more remote computers, such as 116₁, 116₂ . . . 116_{N} are hereinafter described as the remote computer 116.

According to some embodiments of the present invention, the remote computer 116 is a type of a computing device (e.g., a mobile phone, a Personal Digital Assistant (PDA), hand-held gaming device, and/or the like) known to one of ordinary skill in the art having the benefit of this disclosure. The remote computer 116 is utilized by a user to access various data, such as local files or Internet resources (e.g., web pages, multimedia files (e.g., dynamic or static content in the form of images, video and/or audio). The remote computer 116 comprises a CPU 118, support circuits 120, and memory 122. The memory 122 may further include storage and processor (not shown).

According to some embodiments of the present invention, the storage appliance 108 may reside in the local network 101. The local network 101 may also be known as a home network. The storage appliance 108 may be connected to the computer system 102 by suitable networking protocols for facilitating data transfer and access operations. Those skilled in the art may utilize various well known protocols for such purposes without departing the meaning and scope of the invention.

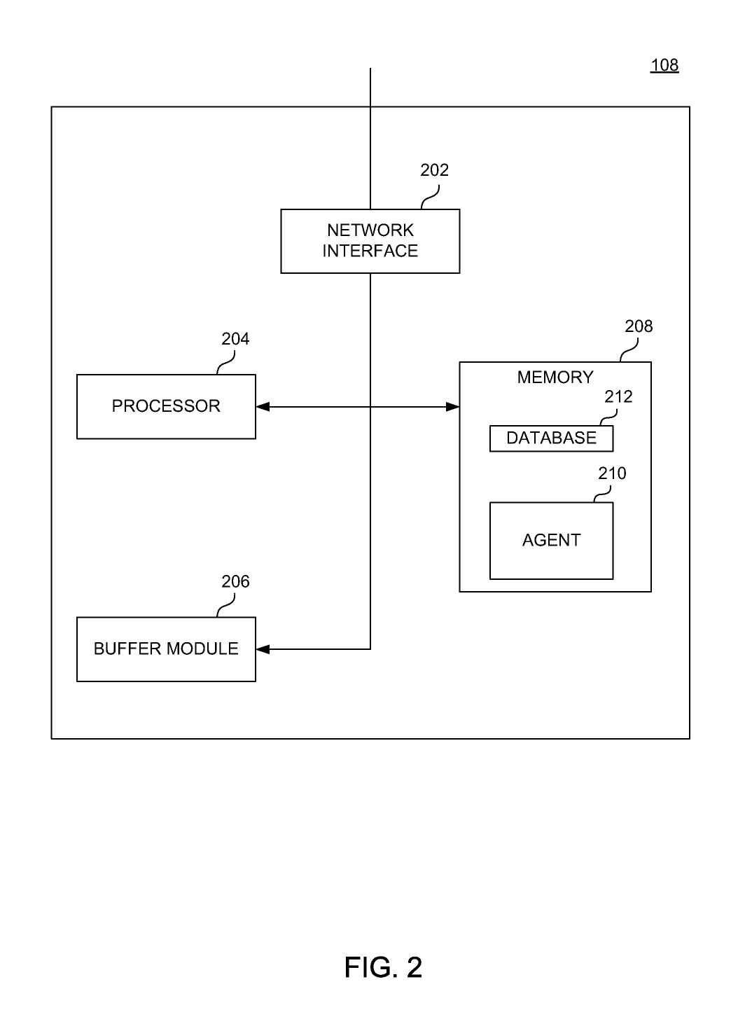

FIG. 2 illustrates a block diagram of the storage appliance 108 facilitating seamless data storage and access of the data according to some embodiments of the present invention. The storage appliance 108 is operatively connected to the computer system 102 in a home network (i.e. the local network 101 of FIG. 1) and seamlessly coordinates for the storage and backup of data stored on the one or more computer systems 102 The storage appliance 108 assists in the offloading of data to the cloud network 104 while maintaining a local cache of data stored on the appliance itself. The storage appliance 108 includes a network interface 202, a processor 204, a buffer module 206 and a memory 208.

According to some embodiments of the present invention, the network interface 202 establishes a connection between the storage appliance 108 and at least one computer (i.e. the computer systems, 102₁, 102₂, . . . 102_{N} of FIG. 1) on the local network. The network interface 202 also provides a connection between the storage appliance 108 and the cloud network 104.

The network interface 202 may be configured to allow data to be exchanged between the storage appliance 108 and other computers attached to a network. In some embodiments, the network interface 202 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

According to some embodiments of the present invention, the buffer module 206 receives data to be backed up from the at least one computer (i.e. the computer systems, 102₁, 102₂, . . . 102_{N} of FIG. 1). The buffer module 206 comprises a mechanism for local storage of data backed up from the computer 102. The buffer module 206 may comprise a hard disk, a flash memory, RAM, or other method of storing data locally on the device. In some embodiments, the buffer module 206 is located within the memory 208 and shares addressable storage space with the control applications of the device. In some embodiments, the buffer module 206 is a separately addressed storage space. The buffer module 206 serves as both a temporary and permanent location for backed up data, operating as a temporary storage location for data to be sent to the cloud network 104 and a permanent location for frequently accessed data. In this manner, the appliance 108 advantageously provides access to frequently accessed data locally without any delay associated with accessing files located on the cloud network 104.

In some embodiments, the memory 208 includes an agent 210 for executing various instructions (e.g., program instructions executable by processor(s) 204). The agent 210 provides for control of the appliance 108 and data access operations performed by the computers 102. During a backup operation, data is streamed across the network to the buffer module 206. The agent 210 then uploads the data from the buffer module 210 to at least one remote computer on the cloud network 104. When a computer 102 accesses the appliance 108, the agent 210 seamlessly renders the backed-up data to the at least one computer (i.e. the computer systems, 102₁, 102₂, . . . 102_{N} of FIG. 1) such that the backed-up data appears to be stored locally. For example, when the remote computer 102 accesses the file system of the appliance 108, the agent 210 displays all files stored both locally and remotely as local to the appliance 108. The agent 210 may display the aggregate storage of the buffer module 206 and the remote computer 116 as a single storage volume. When the computer 102 accesses a particular file, the appliance 108 accesses the appropriate local or remote storage location where the file is stored. The agent 210 also provides one or more algorithms by which files are streamed from the local computers 102 and backed up to the remote computer 116. Such algorithms may prioritize backups by commonly accessed files, files with the most recent changes, file sizes, file types or extensions, or any other method of file selection as known in the art. The agent 210 may also include one or more algorithms for determining which data to cache locally in the buffer module 206 and which data to upload to the remote computer 116. The agent 210 may prioritize locally cached files as files which are most frequently accessed, files which are most inconvenient to retrieve from remote storage (i.e. largest), files of specific types, and the like.

The memory 208 is also comprised of a database 212. The database 212 maintains a set of pointers to files stored locally in the buffer module 206 and on the remote computer 116. When the storage appliance 108 receives a data access request, the database 212 is used to determine the location of the requested data. The database 212 may also include multiple pointers to the same file in order to prevent duplication of data. For example, the same file may be located on two computers 102 for which backup operations are performed. In this case, the storage appliance 108 will only maintain a single copy of the duplicate file with two entries in the database 212 pointing to the same file.

In some embodiments, the agent 210 synchronizes the computer system 102 with the storage appliance 108 via execution of the agent 210. The agent 210 also maintains pointers for the offloaded backup data in a local database 212 stored in the memory 208. The agent 210 erases portions of the backup data that are infrequently accessed to make room in the buffer for more frequently used data. The process of caching frequently used data continuously occurs as data access patterns change. In some embodiments, the agent 210 makes a determination of data that is most likely to be accessed and caches the data on the buffer appropriately. For example, the agent 210 may cache data from similar time periods as recently accessed data, the same file folders as recently accessed data, similar file types as recently accessed data, and the like. Such data cache methods are known in the art and one of ordinary skill would recognize a multitude of ways to cache data according to the various methods.

In some embodiments, the storage appliance 108 synchronizes across various computers (i.e. the computer system 102) and seamlessly back-ups all the data from the computer system 102. The appliance 108 intelligently detects duplicate files and ensures such duplicate files are not backed up twice on the storage appliance 108. Further, the storage appliance 108 may provide a theft recovery feature wherein any illegal user is restricted to access data. In some embodiments, the appliance 108 may receive a command from the cloud network 104 during synchronization. If the owner of the appliance 108 has reported the device as stolen, the command received from the cloud network may cause the device to immediately shut down, erase all local data, wipe the device firmware (effectively rendering the device useless to the thief), or any other type of theft countermeasures as known in the art.

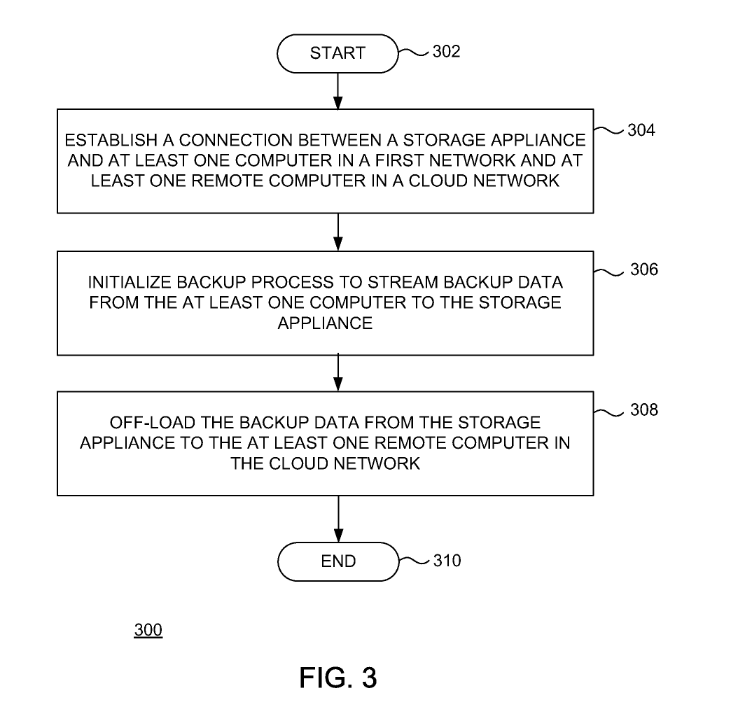

FIG. 3 illustrates a flow diagram of a method 300 for uploading data from the storage appliance 108 to a remote computer in a cloud network according to an embodiment of the present invention. The method 300 starts at step 302 and proceeds to step 304. At step 304, the appliance 108 establishes a connection to at least one computer (i.e. the computer 102) in a local network (i.e. the local network 101) and/or at least one remote computer (i.e. the remote computer 116) in a cloud network (i.e. the cloud network 104). One of ordinary skill in the art would recognize that such a storage appliance 108 would be capable of certain functionality when coupled to either only a local computer or only a remote computer. For example, when coupled only to the local computer, the device would still be capable of accessing data cached in the local buffer. If the device was only coupled to a remote computer, backup, access, and cache operations using the cloud network 104 would still be possible. For the purpose of describing the present embodiment of the invention, it is assumed that the device is capable of communicating with both the local network and the remote network.

At step 306, a backup process is initialized to stream backup data from the at least one computer to the storage appliance 108. The agent 210 enables the processor 204 to stream backup data from the computer system 102 to the buffer module 206 of the storage appliance 108. In some embodiments, the agent 210 performs this process automatically. In some embodiments, an application executing on the local computer 102 operates to interface with the storage appliance 108. Such an application may be implemented as a device driver or a separate backup application as commonly known in the art. Those skilled in the art would recognize a variety of suitable network protocols for transferring such data files from the local computer 102 to the storage appliance 108.

At step 308, the backup data is off-loaded from the storage appliance 108 to the at least one remote computer 116 in the cloud network 104. In some embodiments, the storage appliance 108 intelligently and seamlessly transfers the data from the storage appliance 108 to the remote computer 116. In some embodiments, the backup data is encrypted for transmission to the at least one remote computer 116. In some embodiments, the encryption functionality is provided by the backup agent 210. In other embodiments encryption is provided by the network interface 202. In some embodiments, the encryption process may also provide data compression to reduce the amount of data that is transmitted to the remote computer 116. The method 300 proceeds to step 310, at which the method 300 ends.

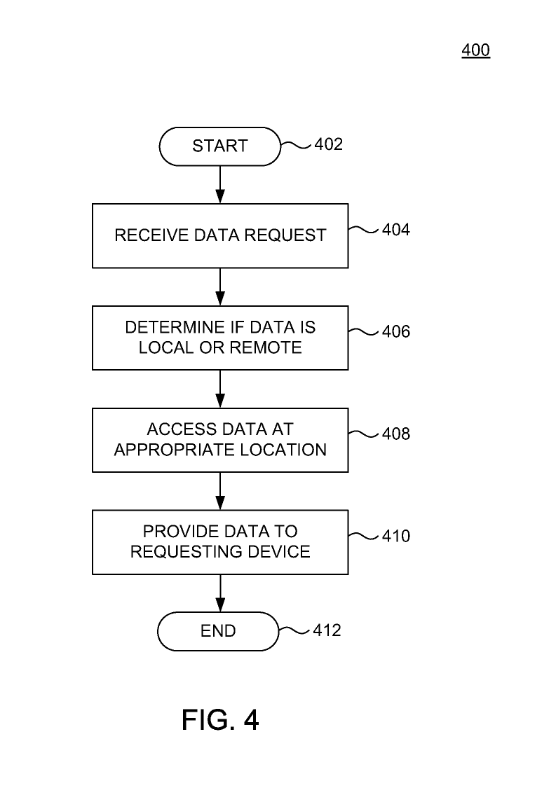

FIG. 4 illustrates a flow diagram of a method 400 for accessing data via the storage appliance 108. At step 402, the method begins and proceeds to step 404. At step 404, the storage appliance 108 receives a data request. In some embodiments, the data request is received directly from file system of the local computer 102 via an installed device driver as commonly known in the art. In some embodiments, the data request is received from a controller application executing on the local computer 102. After the appliance 108 receives the data access request, the method proceeds to step 406.

At step 406, the storage appliance 108 queries the database 212 to determine if the requested data is present locally in the buffer module 206 or remotely on the cloud network 104.

At step 408, the storage appliance 108 accesses the data in the appropriate location. If the data is present locally, then the data is accessed from the buffer module 206. If the data is stored remotely, then the data is accessed from the remote computer 116.

At step 410, the storage appliance 108 provides the requested data to the requesting device. In this manner, the requesting device is unaware of whether the data is stored locally or remotely, as the access operations are transparently performed by the storage appliance 108. The method ends at step 412, after the data is provided to the requesting device.

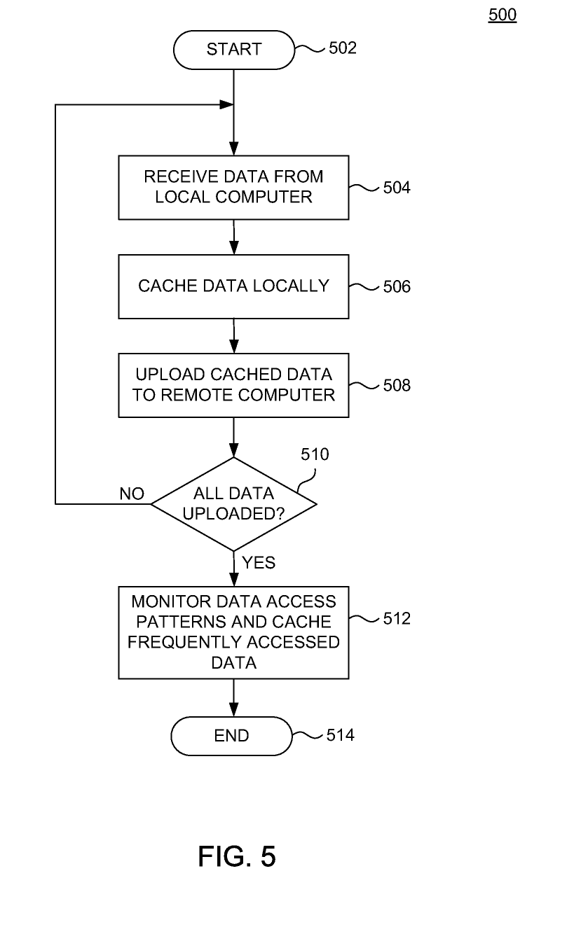

FIG. 5 illustrates a flow diagram of a method 500 for backing up data using a storage appliance in accordance with an embodiment of the present invention. The method begins at step 502 and proceeds to step 504.

At step 504, the storage device 108 receives data from a local computer 102. The data may be received as a result of a request by the agent 210, or the data may be sent by a backup application executing on the local computer 102. In either case, the received data is stored locally on the appliance in the buffer module 206 at step 506.

At step 508, the storage appliance 108 uploads the locally cached data present in the buffer module 206 to the remote computer 116. In some embodiments, the agent 210 or a process executing on the local computer 102 provides an option to select “always local” for data stored via the storage appliance 108. If the user selects the “always local” option, the storage appliance 108 will always ensure that a version of the selected file or files is cached in the buffer module 206. Files selected in this manner would still be backed up to the remote computer 116, but would also be quickly accessible via the cache when needed. After the files are uploaded to the remote computer 116, the appliance 108 may free up the memory within the buffer module 206 to receive new data.

At step 510, if all of the data from the local computer 102 has been uploaded, the method proceeds to step 512. If un-uploaded data remains, the method returns to step 504 and repeats until all data is uploaded to the remote computer 116 on the cloud network 104.

At step 512, after all data has been uploaded to the remote computer 116, the storage appliance 108 monitors data access patterns and caches frequently accessed data in the buffer module 206. As discussed above with respect to FIG. 2, the storage appliance 108 may cache this data in a variety of different ways as known in the art. In some embodiments, the storage appliance 108 may also monitor the file system of the local computer 102 to upload newly modified files to the remote computer 116. The method ends at step 514.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A method for implementing data access via a storage appliance comprising:
receiving a set of data from one or more local computers;
caching the received data locally on the storage appliance in a buffer module;
uploading the cached data to one or more remote computers; and
accessing the set of data using the storage device.

2. The method of claim 1 further comprising monitoring data access patterns using the storage appliance and caching frequently accessed data on the storage appliance.

3. The method of claim 1 further comprising deleting data from the storage device when the data has been uploaded to the one or more remote computers.

4. The method of claim 1, further comprising synchronizing the set of data with a set of data stored on the one or more remote computers.

5. The method of claim 1, further comprising encrypting the cached data when uploading the cached data to the one or more remote computers.

6. The method of claim 3, further comprising maintaining a database of one or more pointers to data stored locally on the storage appliance and remotely on the one or more remote computers.

7. The method of claim 3, further comprising presenting data stored locally on the storage appliance and data stored remotely on the one or more remote computers as data stored locally on the storage appliance for the purpose of data access.

8. The method of claim 6, further comprising:
receiving a data access request from a requesting device, wherein the data access request comprises a particular element of data stored on the storage appliance;
determining if the particular element of data is stored locally or remotely using the database;
accessing the particular element of data at the appropriate storage location; and
providing the particular element of data to the requesting device.

9. The method of claim 1, further comprising sending a command to disable the storage appliance from the one or more remote computers.

10. The method of claim 1, further comprising:
in response to receiving a duplicate file that has already been backed up on the storage appliance, creating a reference to the file already present on the storage appliance.

11. The method of claim 1, further comprising:
presenting a storage volume information for the storage appliance to one or more local computers as the aggregate of the data storage of the buffer module and the one or more remote computers.

12. A storage appliance comprising:
a network interface module for establishing connection of the storage appliance with at least one computer in a local network and at least one remote computer in a cloud network;
a buffer module for receiving data to be backed up from the at least one computer; and
a processor for uploading the received backup data from the storage appliance to the at least one remote computer in the cloud network and rendering the backed-up data to the at least one computer such that the backed-up data appears to be stored locally.

13. The storage appliance of claim 12, wherein the processor synchronizes the at least one computer with the storage appliance.

14. The storage appliance of claim 12, wherein the processor maintains a pointer for the offloaded backup data.

15. The storage appliance of claim 12, wherein the processor monitors data access patterns and caches a set of frequently accessed data locally in the buffer module.

16. The storage appliance of claim 12, wherein the processor synchronizes the backed-up data with a set of data stored on the at least one remote computer.

17. The storage appliance of claim 12, wherein the processor encrypts the backed-up data when uploading the backed-up data to the at least one remote computer.

18. A method for accessing data on a storage appliance comprising:
receiving a data access request from a requesting device, wherein the data access request comprises a particular element of data accessible to the storage appliance;
determining if the particular element of data is stored local on the storage appliance or on one or more remote computers accessible to the storage appliance using a database present on a storage appliance, wherein the database comprises a set of pointers to a location for a given element of data;
accessing the particular element of data at a appropriate storage location as indicated in the database using the storage appliance; and
providing the particular element of data to the requesting device.

19. The method of claim 18, further comprising presenting a storage volume information for the storage appliance to one or more local computers as the aggregate of the data storage of the buffer module and the one or more remote computers.
